(19) United States
(12) Patent Application Publication
(10) Pub. No.: US 2002/0140318 A1
(43) Pub. Date: Oct. 3, 2002

(54) Matrix type actuator

(75) Inventors: Yukihisa Takeuchi, Nishikamo-gun (JP); Hiroyuki Tsuji, Nagoya (JP); Kazumasa Kitamura, Nagoya (JP); Nobuo Takahashi, Nagoya (JP); Koji Kimura, Nagoya (JP)

Correspondence Address: BURR & BROWN, PO BOX 7068, SYRACUSE, NY, 13261-7068, US

(73) Assignee: NGK Insulators, Ltd., Nagoya (JP)

(21) Appl. No.: 09/952,483

(22) Filed: Sep. 12, 2001

Related U.S. Application Data
(63) Continuation-in-part of application No. 09/900,742, filed on Jul. 6, 2001.

(30) Foreign Application Priority Data
Dec. 22, 2000 (JP) 2000-391715
Apr. 6, 2001 (JP) 2001-108986
Jun. 22, 2001 (JP) 2001-189718

(51) Int. Cl. H02N 2/00

(52) U.S. Cl. 310/320

(57) ABSTRACT

A piezoelectric/electrostrictive actuator in which a plurality of piezoelectric/electrostrictive elements each consisting of a piezoelectric/electrostrictive body and at least one pair of electrodes are formed on a thick ceramic substrate, said actuator being activated by the displacement of said piezoelectric/electrostrictive bodies, is provided. The piezoelectric/electrostrictive elements are joined to said ceramic substrate into respective unified bodies, and are two-dimensionally arranged independently of each other. The piezoelectric/electrostrictive actuator ensures providing a greater displacement with a lower voltage, a high responsive speed, and a greater generating force, as well as enhancing the mounting ability and the integration as well as a method for manufacturing such a actuator can be provided.

### CROSS-REFERENCE TO RELATED APPLICATIONS

This application is a continuation in part of U.S. patent application Ser. No. 09/900,742 filed on Jul. 6, 2001.

### BACKGROUND OF THE INVENTION AND RELATED ART

The present invention relates to a matrix type actuator, more specifically, to a matrix type piezoelectric/electrostrictive actuator which may be used in an optical modulator, an optical switch, an electric switch, micro valve, a conveyor apparatus, an image display apparatus, an image drawing apparatus, a pump, a droplet ejecting apparatus, and the like; is provided with a higher generating force and a greater displacement; and preferably being capable of expressing expansion/contraction displacement and/or stretching vibration in a direction perpendicular to the main surface of a ceramic substrate owing to transverse effect of the electric field induced strain of the piezoelectric/electrostrictive element. The present invention also relates to a method for manufacturing such an actuator.

In recent years, a displacement controlling element which permits adjusting the length of a optical path and the spatial position in the order of a sub micron is required in the field of the optics, precision machining engineering, semiconductor manufacturing engineering and so on. For this purpose, a piezoelectric/electrostrictive actuator, which utilizes a strain resulting from the reverse piezoelectric effect or the electrostrictive effect induced by applying an electric field to a ferroelectric material or an antiferroelectric element, has been developed. Compared with the conventional electromagnetic elements, such as servomotors, pulse motors, and so on, such a displacement control element with the aid of the strain induced by the applied electric field has characteristic features such that the micro displacement can be easily attained, and a high efficiency in converting the electric energy to the mechanical energy or vice versa provides a reduction in the consumption of an electric power, and further an extremely high precision in assembling the components provides small and lightweight products. Thus, it is considered that the applicable field thereof will increase continuously.

In an optical switch, for instance, such a piezoelectric/electrostrictive element is normally used to switch transmission channels for an incident light.

An example of such an optical switch is shown in FIGS. 2(a) and (b). The optical switch 200 shown in FIGS. 2(a) and (b) comprises a light transmitting member 201, a light path changing member 208 and an actuator member 211. In a more detailed description, the light transmitting member 201 includes a light reflecting plane 101 disposed in a part of a surface facing the light path changing member 208, and light transmitting channels 202, 204 and 205 directed in three different directions from the light reflecting plane 101, and the light path changing member 208 includes a transparent light incident member 209 movably disposed in the vicinity of the light reflecting plane 101 in the light transmitting member 201 and a light reflecting element 210 for providing a total reflection. Moreover, the actuator member 211 has a mechanism, which is displaced by an applied external signal and then transmits the displacement to the light path changing member 208.

In the optical switch 200, the actuator member 211 is activated by an external signal, e.g., an applied voltage, as shown in FIG. 2(a), and then the light path changing member 208 departs from the light transmitting member 201 by the displacement of the actuator member 211, so that light 221 incident in the light transmitting channel 202 of the light transmitting member 201 is reflected in the total reflection at the light reflecting plane 101 in the light transmitting member 201 without any transmission thereof, and is transferred to one of the light transmitting channels 204 on the exit side.

On the other hand, if the actuator member 211 is changed into the non-active state from this state, the position of the actuator member 211 is turned to the initial position, as shown in FIG. 2(b), and the light incident member 209 in the light path changing member 208 comes into contact with the light transmitting member 201 within the distance less than the wavelength of light, so that the light 221 incident to the light transmitting channel 202 is transmitted from the light transmitting member 201 to the light incident member 209 with the action thereof, and then passes through the light incident member 209. The light 221 passed through the light incident member 209 arrives at the light reflecting element 210, and is transmitted to another light transmitting channel 205 on the exit side on which the light reflected by the light reflecting surface 101 of the light transmitting member 201 proceeds owing to the reflection by the light reflecting surface 102 of this light reflecting member 209.

As the actuator member of an optical switch having such a light path changing function, a piezoelectric/electrostrictive element is preferably used. In particular, in the design of a matrix type switch for switching between several channels, a piezoelectric/electrostrictive actuator including a plurality of piezoelectric/electrostrictive elements of a unimorph or bimorph type (hereafter, being referred to as bending displacement elements) is preferably employed, as disclosed in Japanese Patent No. 2693291 specification. The bending displacement element is constituted by a vibrating plate and piezoelectric/electrostrictive elements, and can provide a greater displacement, in proportion with the length of the piezoelectric/electrostrictive elements, since a slight expansive/contractive strain of the piezoelectric/electrostrictive elements induced by an applied electric field is converted into a bending displacement in the bending mode. However, since the strain was converted in such a way, the stress arising directly from the strain of the piezoelectric/electrostrictive elements could not be directly used, and therefore it was very difficult to increase the magnitude of the generated stress. Moreover, it was also difficult to increase the responsive speed satisfactorily, since the resonance frequency inevitably decreased with the increase of the length of the elements.

Meanwhile, in attaining an enhancement in the performance of an optical switch 200, firstly there is a requirement of increasing the ON/Off ratio (contrast). In this case, it is important to reliably perform the contact/separate action between the light path changing member 208 and the light transmitting member 201, and therefore the actuator member preferably provides a greater stroke, i.e., a greater displacement.

Secondly, there is a requirement of reducing the power loss due to the switching. In this case, it is important to increase the area of the light path changing member 208 together with the increase in the effective area of the light transmitting member 201 coming into contact therewith. Since, however, such an increase in the contact area causes a reduction in the reliability of separation, an actuator generating a greater stress is necessary. Hence, in enhancing the performance of such an optical switch, it is desirable to provide a piezoelectric/electrostrictive actuator including an actuator generating a greater displacement together with a greater force.

It is preferable that the individual piezoelectric/electrostrictive elements are constituted so as to be independent of each other. The independency mentioned herein implies that the generated displacement and the stress resulting therefrom in the respective elements does not interfere with each other, i.e., constrain each other in these elements. For instance, the piezoelectric/electrostrictive actuator 145 shown in FIG. 3 provides a bending displacement due to the activation of piezoelectric/electrostrictive elements 178, as shown in the sectional view of FIG. 4. Each piezoelectric/electrostrictive element 178 is mechanically independent of the adjacent piezoelectric/electrostrictive element with the aid of the rigidity of partition walls 143. However, a substrate 144 is formed in a unified element, and vibrating plates to which the piezoelectric/electrostrictive elements 178 act are also a continuous element. Accordingly, although the respective adjacent piezoelectric/electrostrictive elements are independent of each other by the partition walls 143, a tensile or compressive stress resulting from the action of the piezoelectric/electrostrictive elements 178 provides a certain influence between the piezoelectric/electrostrictive elements. On the other hand, in the piezoelectric/electrostrictive elements 155 shown in the sectional view of FIG. 5, a side walls 219 carrying a vibrating plates 18 is separated from the adjacent side walls 219, thereby providing no interaction with the adjacent elements.

Moreover, as another embodiment, actuators used for an ink jet head, which are disposed in a straight line in conjunction with pressurizing chambers disposed in a straight line, are disclosed in FIG. 2 of JP-A-60-90770. The actuators are formed not by the above-mentioned bending deformation elements, but by piezoelectric/electrostrictive elements, which directly utilize the strain of the piezoelectric/electrostrictive elements. In the actuators, however, electrodes are formed on the upper and lower activation surfaces of the piezoelectric/electrostrictive elements, and in general the piezoelectric constant d33 representing the longitudinal effect of the electric field induced strain is greater than the piezoelectric constant d31 representing the transverse effect of the electric field induced strain. Nevertheless, it was difficult to obtain a greater amount of displacement with a smaller applied voltage, since the distance between the electrodes is large. On the other hand, an actuator used by applying a voltage to the piezoelectric plate in the direction of the thickness thereof is disclosed in FIG. 5. In this actuator, there is used singly a piezoelectric element produced by forming merely electrodes on a piezoelectric plate. Moreover, the piezoelectric element disclosed in JP-A-60-90770 is produced by processing the resultant with cutting, and therefore there is a problem in that the element is not free from damages inherently formed by the machining.

In any way, there has been so far no proposal of providing such a piezoelectric/electrostrictive actuator that piezoelectric/electrostrictive elements having little damage suffered in the manufacturing with both a greater displacement and a high generating force are arranged in the form of a two dimensional matrix, and are unified with the substrate into one body as well.

### SUMMARY OF THE INVENTION

The present invention has been completed, taking the above-mentioned matters into account, and the object of the present invention to be solved is to provide a piezoelectric/electrostrictive actuator which ensures generating a greater displacement and a high generating force with a low voltage applied and a high responsive speed, and is so excellent in the mounting as a high degree of integration is feasible and can preferably be applied to an optical modulator, an optical switch, an electric switch, micro valve, a conveyor apparatus, an image display apparatus, an image drawing apparatus, a pump, a droplet ejecting apparatus, and the like. The object of the present invention is also to provide a method for manufacturing such a piezoelectric/electrostrictive actuator. After many investigations on the piezoelectric/electrostrictive actuators, it is found that the objects can be solved with a matrix type actuator described below.

In accordance with the present invention, there is provided a matrix type actuator as a piezoelectric/electrostrictive actuator in which a plurality of piezoelectric/electrostrictive elements each consisting of a piezoelectric/electrostrictive body and at least one pair of electrodes are formed on a thick ceramic substrate, said actuator being activated by the displacement of said piezoelectric/electrostrictive bodies, characterized in that said piezoelectric/electrostrictive elements are jointed to said ceramic substrate into respective unified bodies, and are two-dimensionally arranged independently of each other.

The actuator according to the present invention, in particular, comprises two types of the actuators.

A first matrix type actuator according to the present invention is an actuator in which the piezoelectric/electrostrictive element is formed by disposing piezoelectric/electrostrictive body vertically on the ceramic substrate and the electrodes are formed on the side surfaces of said body. In the first matrix type actuator, it is desirable that the piezoelectric/electrostrictive elements are expanded/contracted vertically to the main surface of said ceramic substrate due to the transverse effect of electric field induced strain. Moreover, it is preferable that the condition of crystal grains in the wall surfaces of the piezoelectric/electrostrictive bodies of the piezoelectric/electrostrictive elements, where the electrodes is formed on the wall surfaces, is that the crystal grains suffering the transgranular fracture inside the grain is 1% or less, and it is preferable that the degree of profile for the surfaces of the piezoelectric/electrostrictive bodies in the piezoelectric/electrostrictive elements is approximately 8 μm or less. It is also preferable that the surface roughness Rt of the wall surfaces of the piezoelectric/electrostrictive bodies in the piezoelectric/electrostrictive element is approximately 10 μm or less.

The second matrix type actuator according to the present invention is an actuator according wherein the piezoelectric/electrostrictive elements are formed on the ceramic substrate by alternately interleaving stratiform piezoelectric/electrostrictive bodies into stratiform electrodes. In the second matrix type actuator, it is preferable that the piezoelectric/electrostrictive elements are expanded/contracted vertically to the main surface of the ceramic substrate due to the longitudinal effect of electric field induced strain. And it is preferable that the thickness of one layer of the piezoelectric/electrostrictive body in the piezoelectric/electrostrictive elements is 100 μm or less. It is also preferable that the number of layers forming said piezoelectric/electrostrictive body in the piezoelectric/electrostrictive elements is 10 to 100.

In the first and second matrix type actuators, it is preferable that the piezoelectric/electrostrictive body is formed of a material among the piezoelectric ceramics, electrostrictive ceramics, and antiferroelectric ceramics or a composite material which is selectable of the ceramic material and piezoelectric polymer. It is further preferable that the ceramic substrate is formed of the same material as the piezoelectric/electrostrictive body forming said piezoelectric/electrostrictive elements. Moreover, it is preferable that electrode terminals are disposed on the surface opposite to the surface on which the piezoelectric/electrostrictive elements are arranged on the ceramic substrate, and the electrodes and the electrode terminals are wired to each other via through holes or via holes formed in the ceramic substrate.

According to the present invention, furthermore, there is provided a method for manufacturing a matrix type actuator, in which a plurality of piezoelectric/electrostrictive elements consisting of a piezoelectric/electrostrictive body and at least one pair of electrodes are two-dimensionally arranged on a thick ceramic substrate, wherein the method comprising: a step A for obtaining ceramic green lamination structure having through apertures, wherein a plurality of ceramic green sheets including piezoelectric/electrostrictive material as a main component are prepared, said ceramic green sheets are machined with a punch and a die to form apertures at predetermined positions and laminated, and thus the through apertures are formed by connecting said apertures to each other; a step B for preparing ceramic green substrates to be a ceramic substrate at a later stage; a step C for obtaining a sintered lamination structure by laminating the ceramic green lamination structure and the ceramic green substrate, and then sintering and unifying them; and a step D for slicing the sintered lamination structure at the portion corresponding to the ceramic green lamination structure obtained at least said step A; characterized in that said method further comprises a process for forming a plurality of independent piezoelectric/electrostrictive elements on the ceramic substrate.

In the method for manufacturing the matrix type actuator according to the present invention, the step A includes; a first substep for forming first apertures in a first ceramic green sheet with the punch, a second substep for raising the first ceramic green sheet in contact with a stripper in the state of not withdrawing the punch from the first aperture, a third substep for raising the punch in such a manner that the front ends of the punch are withdrawn slightly from the lowest part of the raised first green sheet, a fourth substep for forming second apertures in a second ceramic green sheet with the punch, a fifth substep for raising the second green sheet together with the first ceramic green sheet, and a sixth substep for raising the punch in such a manner that the front ends of the punch are withdrawn slightly from the lowest part of the second ceramic green sheet, whereby the lamination is carried out by repeating the fourth substep to sixth substep, and then the ceramic green lamination structure having through apertures formed by the connection of the apertures can be obtained.

Furthermore, it is preferable that a step for filling the through apertures of said sintered lamination structure at the portion corresponding to said ceramic green lamination structure with a filler is interposed between said step C and said step D.

### BRIEF DESCRIPTION OF THE DRAWINGS

FIG. 1 is a perspective view of an embodiment of a matrix type actuator according to the present invention.

FIGS. 2(a) and (b) are vertical sectional views of a conventional piezoelectric/electrostrictive actuator in an application, where FIG. 2(a) shows the activated state in the application of an optical switch, and FIG. 2(b) shows the deactivated state in the application of the optical switch.

FIG. 3 is a perspective view of an embodiment of a piezoelectric/electrostrictive actuator.

FIG. 4 is a vertical sectional view of an embodiment of a piezoelectric/electrostrictive actuator.

FIG. 5 is a vertical sectional view of another embodiment of a piezoelectric/electrostrictive actuator.

FIGS. 6(a) and (b) show an example of application of a matrix type actuator according to the present invention, where FIG. 6(a) is a perspective view of a part of the actuator in application of a micro valve, and FIG. 6(b) is a schematic vertical sectional view of the operation state of the micro valve.

FIGS. 7(a) and (b) show an example of application of a matrix type actuator according to the present invention, where FIG. 7(a) is a plan view of an optical switch in the application, and FIG. 7(b) is a sectional view viewed from A-A in FIG. 7(a).

FIG. 8 is a perspective view of another embodiment of a matrix type actuator according to the present invention.

FIG. 9 is a perspective view of another embodiment of a matrix type actuator according to the present invention.

FIG. 10 is a perspective view of another embodiment of a matrix type actuator according to the present invention.

FIG. 11 is a perspective view of another embodiment of a matrix type actuator according to the present invention.

FIG. 12 is a perspective view of another embodiment of a matrix type actuator according to the present invention.

FIGS. 13(a) and (b) show vertical sectional views of two different embodiments of a matrix type actuator according to the present invention, respectively.

FIGS. 14(a) to (f) are drawings for explaining a manufacturing method for a matrix type actuator according to the present invention.

FIGS. 15(a) to (f) are drawings for explaining another manufacturing method for a matrix type actuator according to the present invention.

FIGS. 16(a) to (g) are drawings for explaining another manufacturing method for a matrix type actuator according to the present invention.

FIGS. 17(a) to (g) are drawings for explaining another manufacturing method for a matrix type actuator according to the present invention.

FIGS. 18(a) to (e) are drawings for explaining the process of simultaneous punching and laminating ceramic green sheets in the method for manufacturing the matrix type actuator according to the present invention, where FIG. 18(a) shows a preparation step of placing a first ceramic green sheet on a die, FIG. 18(b) shows a step of punching the first ceramic green sheet, FIG. 18(c) shows a preparation step of placing a second ceramic green sheet thereon, FIG. 18(d) shows a step of punching the second ceramic green sheet, and FIG. 18(e) shows a punching completing step in which the laminated green sheets are removed by a stripper after all the sheets are punched and laminated.

FIGS. 19(a) and (b) are drawings for explaining the method for manufacturing the matrix type actuator shown in FIGS. 14(a) to (f), where FIG. 19(a) shows a vertical section viewed in the direction B in FIG. 14(c) and FIG. 19(b) shows a magnified section of part M in FIG. 19 (a).

FIGS. 20(a) and (b) are drawings for explaining the conventional method for manufacturing a piezoelectric/electrostrictive actuator in which the slit machining is carried out after sintering, where FIG. 20(a) shows a section of an element to be machined, viewed from the side thereof, and FIG. 20(b) shows a magnified section of part N in FIG. 20(a).

### DESCRIPTION OF THE PREFERRED EMBODIMENTS

In the following, various embodiments as to the matrix type actuator according to the present invention will be concretely described. However, the present invention is not restricted to these embodiments, and various alterations, revisions and modifications are possible, unless they are beyond the scope of the present invention.

Here, the matrix type actuator according to the present invention belongs to a piezoelectric/electrostrictive actuator, and therefore it is an actuator in which an electric field induced strain is utilized. However, the matrix type actuator is not restricted to an actuator, in which the piezoelectric effect of generating a strain substantially proportional to an applied electric field or the electrostrictive effect of generating a strain substantially proportional to the square of an applied electric field is utilized in a narrow sense, but it also includes an actuator in which a phenomenon of a polarization reversal for inversion found in ferroelectric materials, or a transition between the antiferroelectric phase and the ferroelectric phase found in antiferroelectric materials, or the like is utilized. Moreover, it is also optional as for whether or not the polarization treatment should be carried out. This is appropriately determined on the basis of the nature of the material for piezoelectric/electrostrictive body of piezoelectric/electrostrictive elements forming the piezoelectric/electrostrictive actuator. Accordingly, in the present specification, it should be assumed that the materials are intended for the treatment of polarization, when it is said that the polarization treatment is carried out.

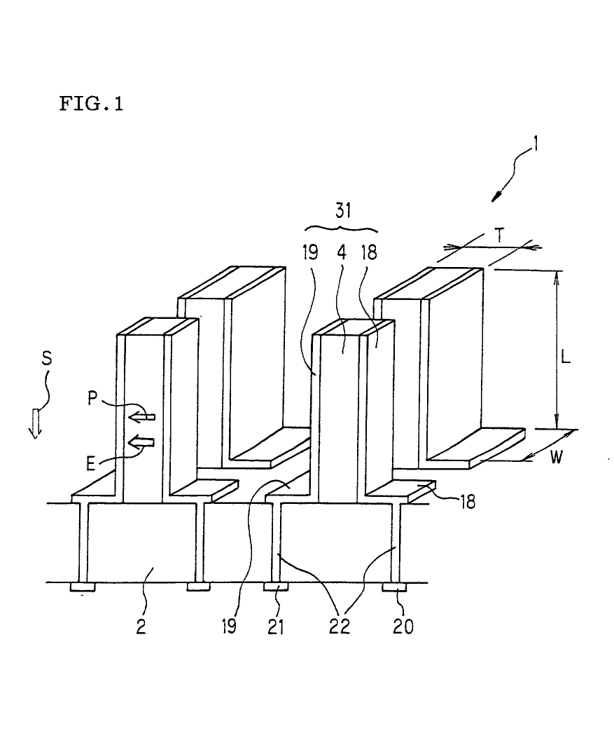

The preferred embodiments of the present invention will be described below by referring now to the accompanied drawings. FIG. 1 is a perspective view of an embodiment of a first matrix type actuator according to the present invention. The matrix type actuator 1 is constituted by a plurality of piezoelectric/electrostrictive elements 31 each consisting of a piezoelectric/electrostrictive body 4 and a pair of electrodes 18 and 19 on a ceramic substrate 2, and the matrix type actuator is activated by the displacement of the piezoelectric/electrostrictive bodies 4 on the ceramic substrate 2. The matrix type actuator 1 according to the present invention has the following characteristic features, which are common to the first matrix actuator:

1) Elements Orderly Arranged in Two Dimension

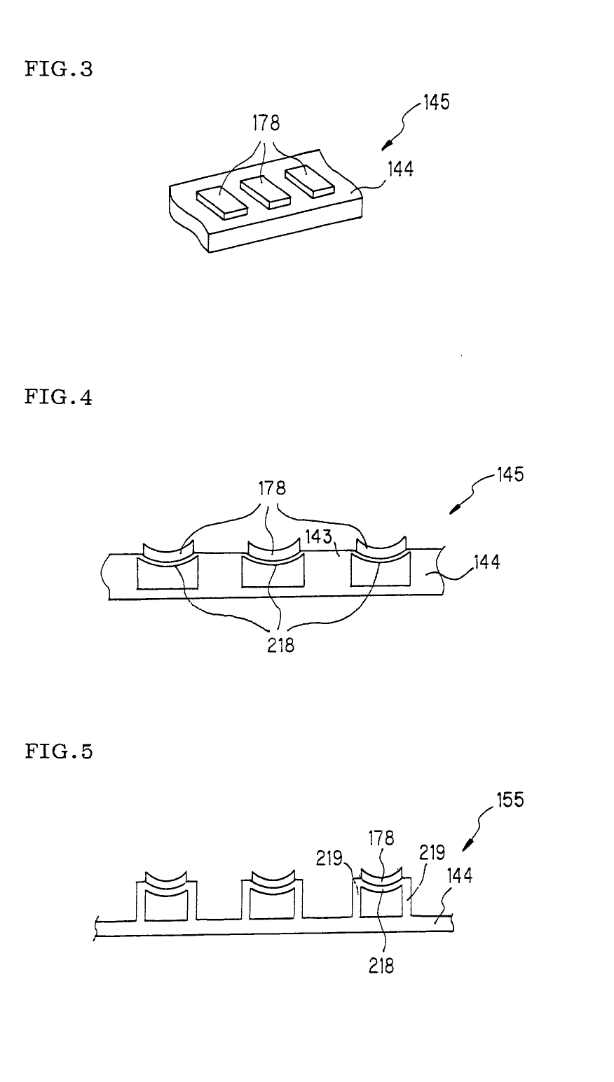

Piezoelectric/electrostrictive elements 31 are orderly arranged on a thick and substantially solid ceramic substrate 2 in the form of two-dimensional matrix in such a manner that they are independent of each other and are unified with the ceramic substrate 2 into one body, but they are not the one wherein piezoelectric/electrostrictive elements are arranged in a line on the substrate in the above-mentioned conventional piezoelectric/electrostrictive actuator 145, as shown in FIG. 3. Such a structural arrangement ensures a high accuracy in determining the size of the elements, the pitch therebetween and so on, and also permits more accurately mounting the elements when they are used as an actuator for a optical switch, a micro valve, an image display apparatus or the like. In addition, the unified structure provides an excellent strength and a high working efficiency in mounting the elements. The term “thick” herein is used in a sense that the substrate does not serve as a diaphragm.

2) Mutually Perfectly Independent Elements

In the matrix type actuator 1 according to the present invention, the parts generating the displacement correspond to only the parts of the piezoelectric/electrostrictive elements 31 exposed to the outside on the ceramic substrate 2, and there are no parts which are deformed due to the strain induced by the applied electric field in the piezoelectric/electrostrictive body 4 as the structure of the ceramic substrate 2. Each piezoelectric/electrostrictive element 31 is independent of the adjacent piezoelectric/electrostrictive elements 31 and therefore provides no disturbance in the mutual displacements even in a structure unified with the ceramic substrate. As a result, a greater displacement can be stably obtained with a smaller voltage.

3) The Formation of Electrode Terminals

The matrix type actuator 1 is constituted in such a manner that piezoelectric/electrostrictive elements 31 are disposed vertically on the ceramic substrate 2 and electrodes 18 and 19 are formed on the side surfaces of the respective piezoelectric/electrostrictive bodies 4. Electrode terminals 20 and 21 are formed on the surface opposite to the surface of the ceramic substrate 2 on which the piezoelectric/electrostrictive elements 31 are disposed. The electrode 18 and the electrode terminal 20, and the electrode 19 and the electrode terminal 21 are formed inside the ceramic substrate 2, and they are wired with via holes 22 into which an electrical conductive material is stuffed. As a matter of course, through holes, onto the inner surface of which an electrical conductive material is applied, can be used instead of the via holes 22. The formation of the electrode terminals on the side opposite to the side on which the piezoelectric/electrostrictive elements 31 of the driving member are arranged provides ease in the subsequent work for connecting the terminals to the power supply, thereby allowing the reduction of yield to be suppressed in the manufacturing process.

4) The Parallelism of the Polarization and the Electric Field for Activation

In the matrix type actuator 1, the piezoelectric/electrostrictive bodies 4 forming the piezoelectric/electrostrictive elements 31 are polarized in the direction P parallel to the main surface of the ceramic substrate 2 in FIG. 1. The electrode terminals 20 and 21 are connected to the power supply, and a voltage is applied between the electrodes 18 and 19 so as to be a positive electrode for the former and to be a negative electrode for the latter, so that an electric field for activation is generated in the direction E. In other words, the electric field for polarization in the piezoelectric/electrostrictive bodies 4 is aligned in the same direction as the electric field for activation. As a result, the piezoelectric/electrostrictive elements 31 are contracted in the direction S perpendicular to the main surface of the ceramic substrate 2 due to the transverse effect of the electric field induced strain of the piezoelectric/electrostrictive bodies 4, whereas the piezoelectric/electrostrictive elements 31 are expanded by the electric field in the direction opposite to the polarization direction P in 180° (however, the electric field has an field strength inducing no reversal of polarization). Since the electric field for polarization in the piezoelectric/electrostrictive bodies 4 forming the piezoelectric/electrostrictive elements 31 is aligned to be parallel to the electric field for activation, in the manufacturing process, it is not necessary to prepare temporary or dummy electrodes for polarization and to apply an electric field thereto in the case of using a mode, for instance, the shear mode (d15), at which the direction of the polarization is not parallel to the electric field for activation, hence, enabling the throughput to be enhanced. Moreover, irrespective of the treatment of polarization, the manufacturing process in which the heating at a temperature higher than the Curie temperature is carried out can be employed. As a result, either soldering with the reflow soldering method or the treatment of bonding with a thermosetting resin can be employed in fixing and wiring the piezoelectric/electrostrictive actuator to, for instance, a circuit board, and therefore the throughput can be further enhanced, inclusive of the manufacturing process of the products involving the actuators, thereby enabling the production cost to be reduced. The state of polarization is not changed, even if greater field strength is used to activate the actuator, rather a more desirable state of polarization can be obtained, and therefore a greater strain can stably be obtained. Thus, one may produce a more compact actuator that is a preferable property as an actuator.

5) Expanding/contracting Displacement

The actuator utilizes the strain due to the expansion/contraction of the piezoelectric/electrostrictive bodies 4 resulting from the applied electric field not by converting the strain into the displacement in the bending mode, but by directly using the expansion/contraction for the displacement. As a result the preset value in the design for obtaining a large displacement is not attributed to the reduction in generating force or stress. The respective piezoelectric/electrostrictive elements forming the first matrix type actuator generate a displacement X_{B}, which can generally be expressed as,

$${X}_{B} = \frac{L}{T} {d}_{31} V , \qquad Eq . ( 1 )$$

and correspondingly generates a stress F_{B}, which can be expressed as,

$${F}_{B} = W \frac{{d}_{31}}{{S}_{11}^{E}} V . \qquad Eq . ( 2 )$$

That is, the displacement and generating force or stress can be separately determined in the design work, where T, L and W are the thickness, height and width of the piezoelectric/electrostrictive element, respectively and

S^{E}₁₁ Eq. (3),

is the elastic compliance. As can be taken from these equations, it is favorable, structure-wise, to make the thickness T of piezoelectric/electrostrictive body thinner and make the height thereof higher in order to balance a displacement and a generating force at the same time. However, it is normally very difficult to treat such a thin plate, and therefore it is impossible to arrange them in high accuracy. The matrix type actuator according to the present invention can be unitarily formed utilizing the manufacturing method described later, without either treating the individual piezoelectric/electrostrictive bodies or arranging them individually; and therefore the present matrix type actuator has such a feature that one may draw out the benefit being provided with such a structure of the piezoelectric/electrostrictive element as mentioned above to its maximum extent.

In the following, referring to the drawings, embodiments of the first matrix type actuator according to the present invention will be further described. The matrix type actuator, which will be described below, also has at least the above-mentioned characteristic features 1) and 2), and more preferably further has the characteristic features 3) to 5). FIG. 9 is a perspective view of another embodiment of the first matrix type actuator according to the present invention. The matrix type actuator 90 is constituted in such a manner that a plurality of piezoelectric/electrostrictive elements 33, each consisting of a piezoelectric/electrostrictive body 4 and a pair of electrodes 18 and 19, are orderly arranged on a ceramic substrate 2, and a cell 3 is formed by closing with a plane plate 7 the surface on the side opposite to that of the ceramic substrate 2 on which each pair of adjacent piezoelectric/electrostrictive elements 33 stands. The piezoelectric/electrostrictive body 4 expresses a strain due to the applied electric field on the ceramic substrate 2, so that the actuator is activated as a result of the expansion/contraction of the piezoelectric/electrostrictive elements 33.

One may expand/contract a pair of piezoelectric/electrostrictive elements 33 simultaneously, one may expand/contract only either one of them, or it may be preferable that one may make such an opposite movement that either one of them is expanded and the other is contracted. When, for example, a plurality of the plane plates 7 that are the activation surface is pushed against an object to be pressed, the object to be pressed may be pressed with a greater driving force if a simultaneous expansion of a plurality of piezoelectric/electrostrictive elements 33 is used to push the plurality of the plane plates 7 against the object, compared with the expansion of a single piezoelectric/electrostrictive element 33. This means that the present case is identical with the case in which the width W of the piezoelectric/electrostrictive element becomes 2W. Furthermore, the cell structure in this case preferably provides a greater mechanical strength, and a greater displacement and a greater generating force as well due to the existence of the plane plate 7, compared with the structure of a single element, even if the thickness T of the piezoelectric/electrostrictive element is reduced. Moreover, one may incline the plane plate 7 with an angle from the horizontal surface by moving them in such an opposite manner that either one of them is expanded, and that the other is contracted or by operating only either one of them. Therefore, if a micro mirror is used as a plane plate 7, for instance, the application field of the present actuator may be expanded to an optical system in which the reflecting angle with respect to an incident beam is altered.

Although it is not depicted, one may form an actuator with a set of three or more piezoelectric/electrostrictive elements as piezoelectric/electrostrictive element 33, and combining them by covering them with a plane plate 7 the surface opposite to the ceramic substrate 2. Furthermore, one may form a closed cell 3 by constituting the four side faces thereof with the piezoelectric/electrostrictive elements 33.

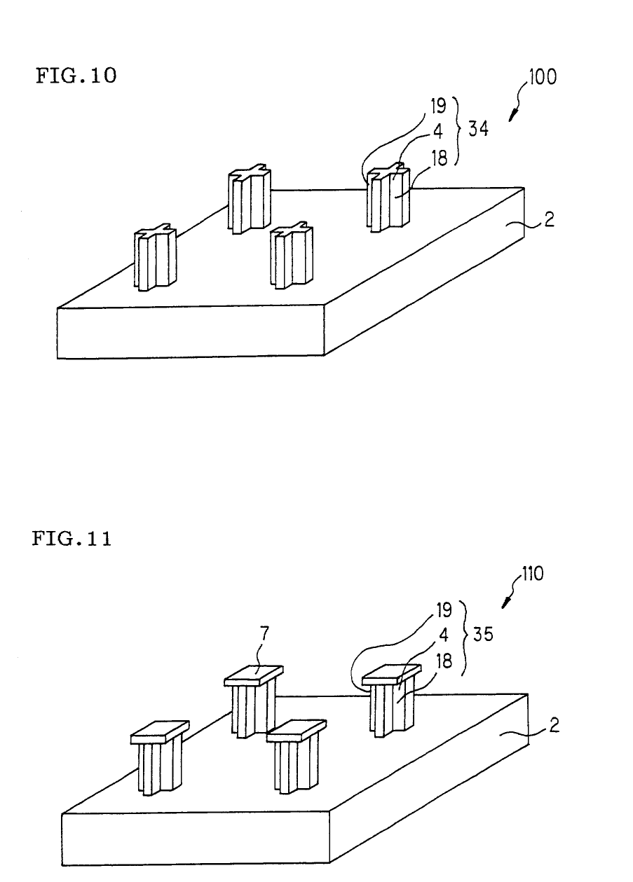

FIG. 10 is a perspective view of another embodiment of a first matrix type actuator according to the present invention. The matrix type actuator 100 is constituted by arranging adjacently a plurality of piezoelectric/electrostrictive elements 34 consisting of piezoelectric/electrostrictive bodies 4 having a cross-shaped horizontal section and a pair of electrodes 18 and 19 on a ceramic substrate 2. The piezoelectric/electrostrictive bodies 4 generate a strain on the ceramic substrate 2 due to an applied electric field, so that the piezoelectric/electrostrictive elements 34 is activated as a result of the expansion/contraction thereof.

A greater rigidity as a structure will increase and an axis of displacement is fixed if one may make the shape of the piezoelectric/electrostrictive body 4 a cross-like shape, so that the direction of displacement may be more stabilized, compared with the matrix type actuator 1 shown in FIG. 1, and a generating force based on the strain will become larger.

FIG. 11 shows a matrix type actuator 110 in which a plane plate 7 is adapted to the surface of each piezoelectric/electrostrictive elements 34 on the side opposite to the side of a ceramic substrate 2 in the matrix type actuator 100 shown in FIG. 10. Similarly to the matrix type actuator 100, a plurality of piezoelectric/electrostrictive elements 35 are adjacently arranged on the ceramic substrate 2, the piezoelectric/electrostrictive bodies 4 generate strain due to the applied electric field on the ceramic substrate 2, so that the piezoelectric/electrostrictive elements 35 are activated by the expansion/contraction.

Compared with the matrix type actuator 100, a rigidity of the structure is greatly increased because, in addition to the cross-shaped piezoelectric/electrostrictive bodies 4, are co-used the plane plate 7. As a result, the axis of displacement is very accurately determined and, therefore, the direction of displacement is further stabilized. Moreover, with utilizing a greater generating force being generated, the plane plates 7 further provide a greater area for pressure, when, for instance, the actuator is pressed against an article to be pressed.

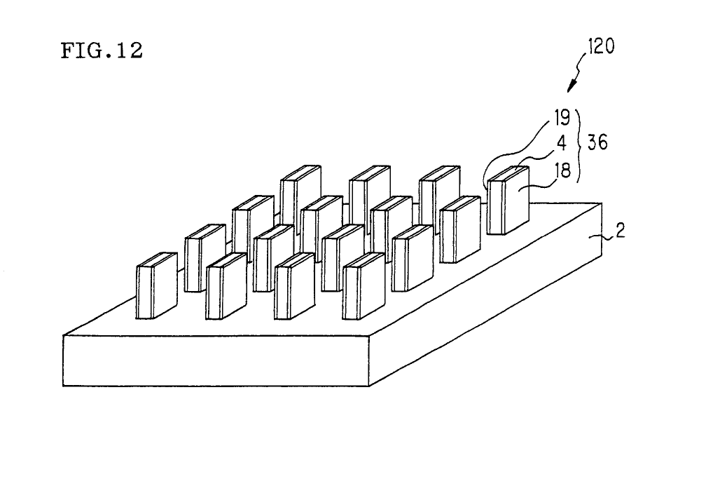

FIG. 12 shows a matrix type actuator 120, which is almost the same as the matrix type actuator 1 in FIG. 1. In this case, electrodes 18 and 19 are not horizontally expanded on the substrate, and are connected to electrode terminals (not depicted) on the backside just below the electrodes 18 and 19 on the side surfaces through via holes or through holes (not depicted). Similarly, a plurality of piezoelectric/electrostrictive elements 36 is adjacently disposed on the ceramic substrate 2. Each piezoelectric/electrostrictive body 4 generates a strain on the ceramic substrate 2 due to an applied electric field, and each piezoelectric/electrostrictive element 36 is activated by the expansion/contraction thereof.

In the following, a second matrix type actuator according to the present invention will be described.

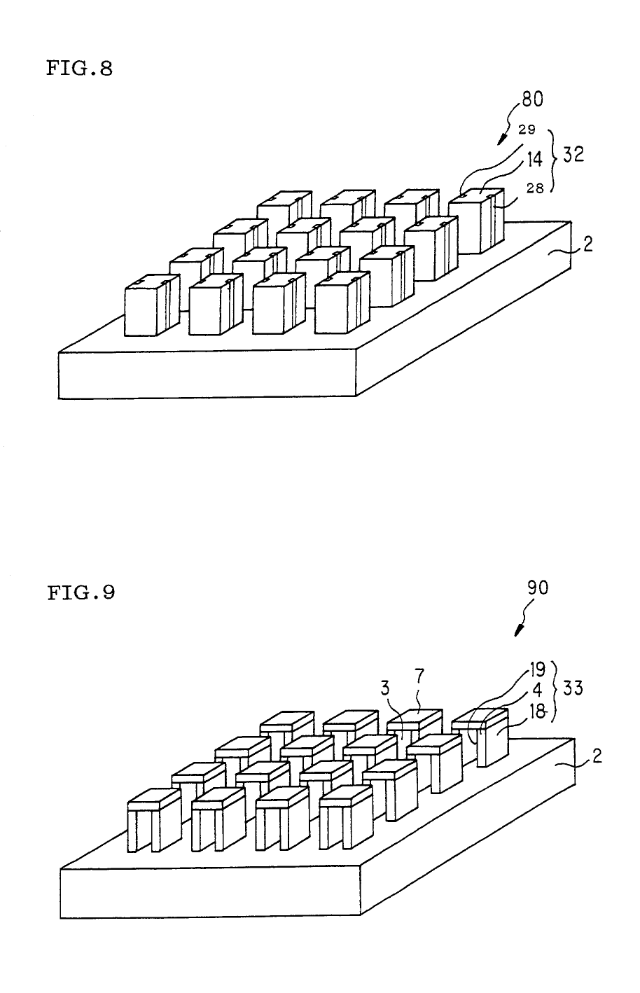

FIG. 8 shows a perspective view of an embodiment of a second matrix type actuator according to the present invention. The matrix type actuator 80 comprises a plurality of piezoelectric/electrostrictive elements 32 each including a piezoelectric/electrostrictive body 14, a pair of electrode, more specifically, a pair of common electrodes 28 and 29 and internal electrodes 48 and 49 on a ceramic substrate 2, and the actuator is a piezoelectric/electrostrictive actuator in which each piezoelectric/electrostrictive body 14 generates a strain due to an applied electric field on the ceramic substrate 2, thereby enabling the activation to be achieved. The second matrix type actuator 80 has at least the characteristic features 1) elements orderly arranged in two dimension and 2) perfect mutual independent elements, similarly to the first matrix type actuator, and preferably has the characteristic features 3) the formation of electrode terminals, 4) the parallelism of the polarization and the electric field for activation, and 5) expanding/contracting displacement.

However, the second matrix type actuator is different from the first matrix type actuator in the following two points:

Firstly, the piezoelectric/electrostrictive elements are not those wherein piezoelectric/electrostrictive elements having an approximately rectangular parallelepiped shape are vertically disposed on the ceramic substrate, and a pair of electrodes is formed on the side surfaces of the piezoelectric/electrostrictive bodies, as described in the item, 3) the formation of electrode terminals, but those wherein stratiform piezoelectric/electrostrictive bodies and stratiform internal electrodes are laminated alternately on the ceramic substrate. Secondarily, the piezoelectric/electrostrictive elements are not only expanded/contracted vertically with respect to the main surface of the ceramic substrate by the displacement due to the transverse effect of the electric field induced strain of the piezoelectric/electrostrictive elements, as described in the item, 4) the parallelism of the polarization field and the electric field for activation, but also expanded/contracted vertically with respect to the main surface of the ceramic substrate by the displacement due to the longitudinal effect of the electric field induced strain.

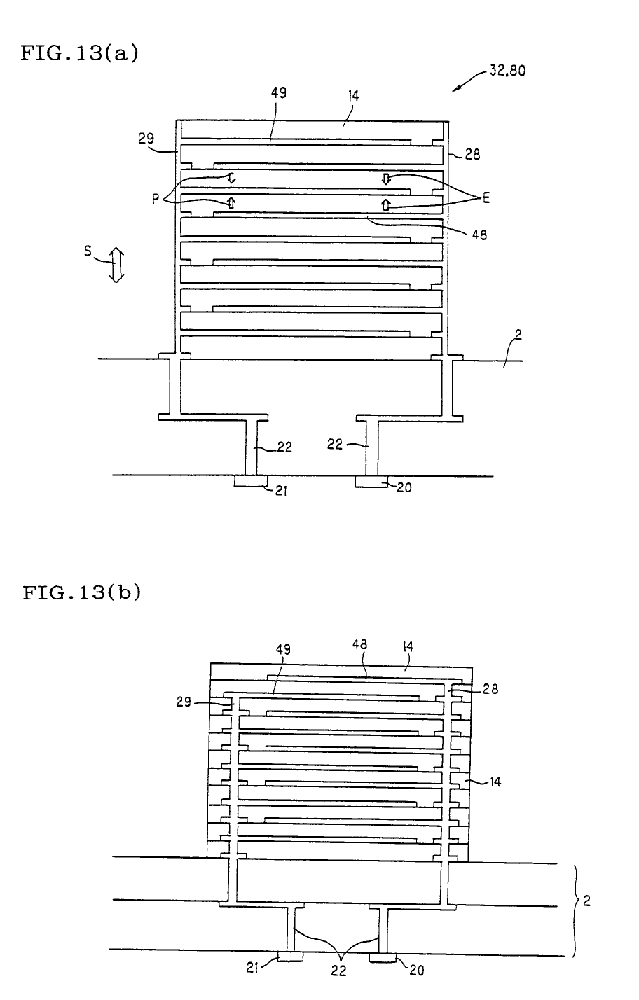

FIG. 13(a) is a vertical sectional view of the piezoelectric/electrostrictive elements 32 in the matrix type actuator 80 shown in FIG. 8; said view being viewed from the vertical section wherein the common electrodes 28 and 29 and the internal electrodes 48 and 49 pass through.

In the matrix type actuator 80, the piezoelectric/electrostrictive element 32 has 10 layers of the piezoelectric/electrostrictive bodies 14, wherein the stratiform piezoelectric/electrostrictive bodies 14, and the stratiform internal electrodes 48 and 49 are laminated alternately. The number of laminated piezoelectric/electrostrictive layers, however, will be chosen, depending upon the application and the aim of usage. It is preferably 10 to 100 layers, in view of the stability in the actuator characteristics and the easiness in production.

In the matrix type actuator 80, piezoelectric/electrostrictive bodies 14 forming the piezoelectric/electrostrictive elements 32 are polarized, e.g., in direction P in the drawing, and the power supply is connected to the electrode terminals 20 and 21. An electric field in direction E is generated by applying a voltage between the common electrodes 28 and 29 such that the common electrode 28 becomes plus and the common electrode 29 becomes minus. That is, the stratiform piezoelectric/electrostrictive bodies 14 polarized in the direction opposite to each other are laminated in such a manner that they are alternately interleaved between the adjacent internal electrodes 48 and 49, and the polarization field is aligned in the same direction as the electric field for activation in each piezoelectric/electrostrictive body 14. As a result, each piezoelectric/electrostrictive body generates an electric field induced strain, and therefore the piezoelectric/electrostrictive elements 32 are expanded/contracted in direction S, i.e., in the direction of lamination, by the displacement due to the longitudinal effect of the strain. Since this expansion/contraction displacement is not the bending displacement such as the conventional unimorph or bimorph and results from the direct usage of the electric field induced strain, a greater generating force and a higher responsive speed can be obtained. Moreover, the piezoelectric/electrostrictive elements of this type are excellent from the viewpoint of the generating force and the responsive speed, compared with piezoelectric/electrostrictive elements shown in FIG. 1 and others, where said elements utilize the transverse effect of the electric field induced strain. The amount of displacement generated from each layer is small. Since, however, the amount of displacement is proportional to the number of piezoelectric/electrostrictive layers, more accurately the number of sets each comprising a pair of piezoelectric/electrostrictive layers and a pair of electrodes, a greater amount of displacement can be obtained by increasing the number of layers. However, there are disadvantages in that the increase of the number of layers brings a reduction of the reliability regarding the electrical connection between the common electrodes and the internal electrodes, and an increase in the consumption of electricity due to the increase in the capacitance, in addition to an increase in the number of process steps.

Moreover, in the matrix type actuator 80 shown in FIG. 8, the thickness per layer of piezoelectric/electrostrictive body 14 should be preferably 100 μm or smaller, more preferably 10 to 80 μm in order to activate it at a low voltage.

In FIG. 13(a), the common electrodes 28 and 29 are exposed to the outside of the piezoelectric/electrostrictive elements. However, it is possible to dispose the common electrodes inside the piezoelectric/electrostrictive elements, as shown in FIG. 13(b). In this case, since the respective electrodes in the piezoelectric/electrostrictive elements are isolated from the outside, the pitch between the adjacent elements may be made smaller. Therefore, this constitution is preferable for an actuator having a higher density.

Referring now to the drawings, the first and second matrix type actuators according to the present invention will be described for examples of application. In the following description, the first or second matrix type actuator is referred to simply as an actuator. Moreover, any of the first and second matrix type actuators can be employed as for an actuator component in the following examples of application.

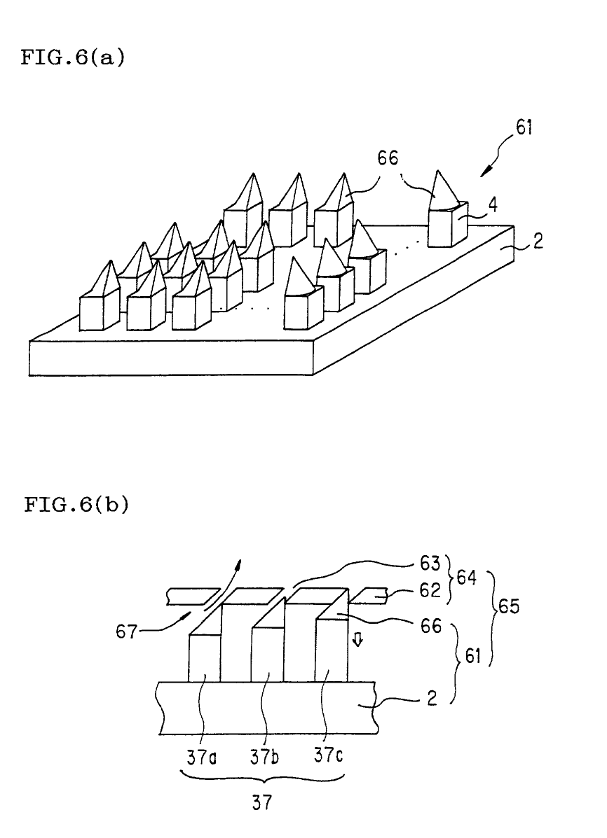

FIGS. 6(a) and (b) show a matrix type actuator according to the present invention, which is employed as a micro valve unit, where FIG. 6(a) is a perspective view of the actuator component of the micro valve unit, and FIG. 6(b) is a vertical sectional view of the micro valve unit. A micro valve 65 comprises a valve seat member 64 and an actuator member 61, and it is a micro valve unit in which a matrix type actuator is used as an actuator member 61.

The valve seat member 64 includes an opening 63 paired with each of the piezoelectric/electrostrictive elements 37 in the actuator member 61. The actuator member 61 comprises a piezoelectric/electrostrictive element 37 capable of displacing in accordance with an external signal, and a valve body member 66 disposed on the surface of the piezoelectric/electrostrictive element 37 opposite to the ceramic substrate 2. The displacement of the piezoelectric/electrostrictive element 37 in the actuator member 61 may change a space of the cross section for the flow through the opening 63 by approaching/separating the valve body member 66 towards/from the opening 63 in the valve seat member 64. By this action, for instance, the flowing amount of fluid 67 passing through the opening 63 can be adjusted.

In the micro valve 65, a space of the cross section of flow in the opening 63 can be freely adjusted by changing the displacement of the piezoelectric/electrostrictive elements 37. FIG. 6(b) schematically shows the state of the piezoelectric/electrostrictive elements 37, where, if the piezoelectric/electrostrictive elements are those in FIG. 1, the piezoelectric/electrostrictive element 37a on the left side in FIG. 6(b) is in a contracted state under the applied voltage, and the opening 63 in the valve body member 66 is completely opened, thereby the flowing amount of fluid 67 passing through the opening 63 to be maximized. In FIG. 6(b), moreover, the piezoelectric/electrostrictive element 37c on the right side is in the inactivated state, and the opening 63 in the valve body member 66 is completely closed, thereby the fluid 67 is blocked in the opening 63. By changing the amount of the displacement of the piezoelectric/electrostrictive element 37, it is possible to arbitrarily set the states of the piezoelectric/electrostrictive elements 37a to 37c. As a result, the flow cross section area of the opening 63 can be freely adjusted, so that the flowing amount of the fluid 67 passing through the opening 63 can also be controlled. The middle piezoelectric/electrostrictive element 37b is set in such a state. Consequently, the micro valves 65 serve to function not only as an ON/OFF valve, but also as a regulating valve. The shape of the opening 63 and the valve body member 66 is not restricted to that shown in this example. One may determine the shape of the opening 63 and the valve body member 66 in a manner similar to the ordinary valve after studying whether the relationship between the displacement of piezoelectric/electrostrictive element 37 and the flowing amount of fluid 67 is set to be linear or quadric, and the like.

The micro valve enables the flowing amount of a fluid passing through the opening to be freely controlled. It is therefore possible to arbitrarily change the pressure of the fluid, for instance air, blowing out from the opening. As a result, the micro valve unit can be used as a conveyor apparatus where an article to be conveyed on the openings is transferred from a place to another place to regulate its position by the corrugated alteration of the pressure at the upper position of the openings, using the pressure in the micro valves. A lightweight article to be conveyed, such as a paper, can be conveyed without any contact therewith in a floating state, and therefore such a conveyor apparatus can preferably be used for conveying printed matters.

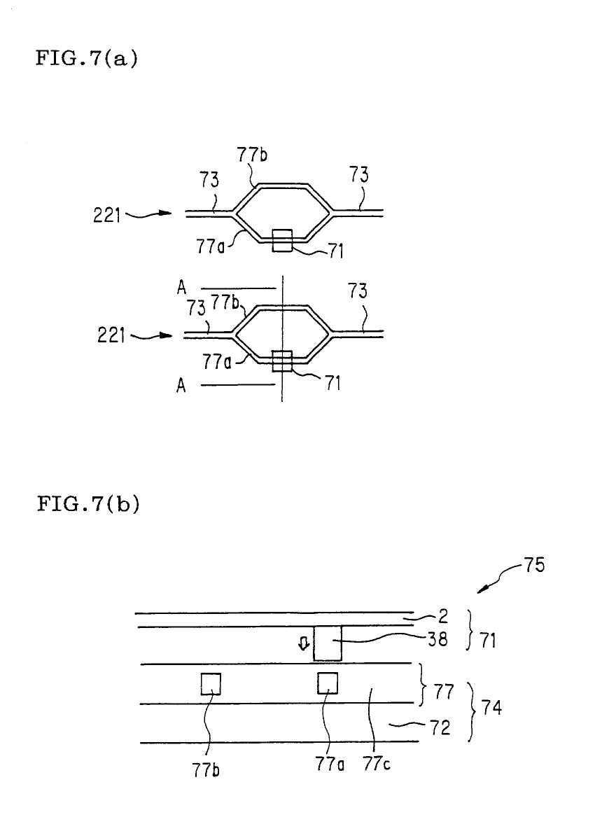

FIGS. 7(a) and (b) show an embodiment of an optical modulator formed by combining a matrix type actuator according to the present invention and an optical interferometer, where FIG. 7(a) shows an upper part of the optical interferometer and FIG. 7(b) shows a cross section viewed from line A-A in FIG. 7(a). The optical interferometer 74 includes two directional couplers 73 and two arm-shaped optical wave guide cores 77a and 77b connected thereto. The optical modulator 75 includes actuators 71 for providing a stress to at least a part in one of the optical wave guide cores 77a and 77b in the optical interferometer 74.

As shown, for instance, in FIG. 7(b), an actuator 71 is disposed, which faces the optical wave guide core 77a in an optical wave guide 77 (for instance, a quartz wave guide or a wave guide made of polymer, such as polyimide) comprising a cladding 77c and the optical wave guide cores 77a and 77b on a substrate (for instance, silicon). Two structural arrangements are possible; one of which includes an air gap between the actuator 71 and the optical wave guide 77, and a stress is transferred between them by coming into contact them with each other in a possible necessary case, whereas the other of which includes no air gap between them, so that the stress can be directly applied between them.

The modulation of light is carried out in such a manner that the application of a stress to the optical wave guide core 77a provides a change in the refractive index of the core and thereby generates a phase difference between two beams of light which propagate respectively in the arm-shaped optical wave guide cores 77a and 77b, thus providing light intensities in accordance with the phase difference. If, therefore, one sets phase difference at a specified level, two values corresponding to the elimination of propagating light (OFF) and the occurrence of light (ON) can be out put. Accordingly, if these optical modulators are arranged in two dimensions, the switching of the light transmission channels can be achieved using the above-mentioned ON/OFF mechanism. The matrix type actuator according to the present invention has a basal portion and is constituted as a planar body. Therefore it may be advantageously arranged so as to face it to the two dimensionally arranged optical interferometers. A greater displacement in the matrix type actuator according to the present invention does not require any high accuracy in setting the air gap. Although a relatively large stress is required in order to provide a change in the refractive index of the optical wave guide core, this may easily be attained by the greater generating force of the matrix type actuator according to the present invention.

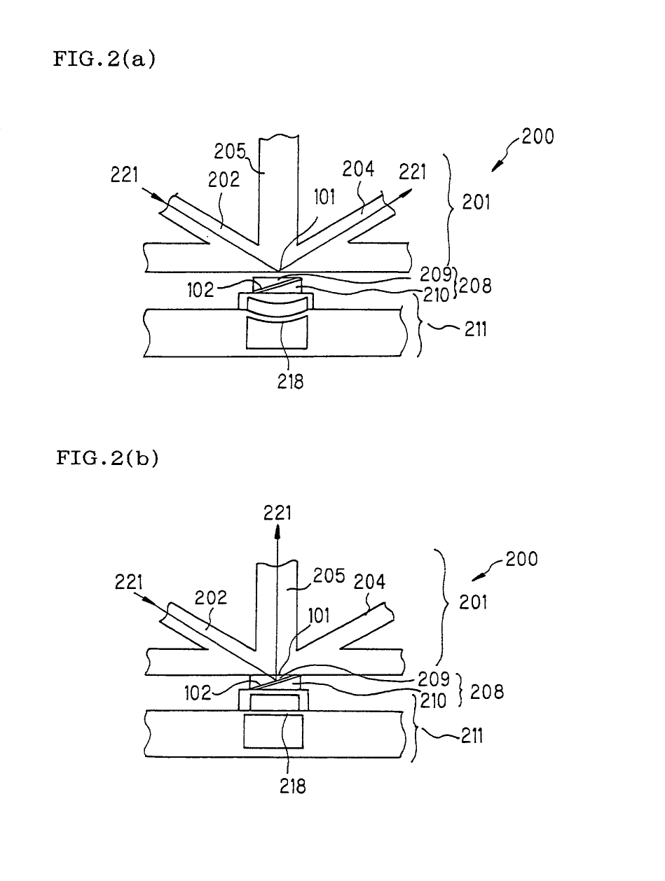

The matrix type actuator according to the present invention can be employed as an actuator member in the optical switch 200 in FIGS. 2(a) and (b), instead of the actuator member 211 shown therein. The optical switch 200 shown in FIGS. 2(a) and (b) comprises the light transmitting member 201, the light path changing member 208 and the actuator member 211. The light transmitting member 201 further includes the light reflecting plane 101 disposed in a part of the surface facing the light path changing member 208 and the light transmitting channels 202, 204, and 205 directed in three different directions from the light reflecting plane 101. The light path changing member 208 includes the transparent light incident member 209 movably approaching the light reflecting plane 101 in the light transmitting member 201, and the light reflecting element 210 for reflecting the light by the total reflection. Moreover, the actuator member 211 includes the mechanism for transmitting the displacement caused by the external signal to the light path changing member 208, so that the light path changing member 208 comes into contact with the light reflecting plane 101 in the light transmitting member 201 or separates therefrom by means of the activation of the actuator member 211, and therefore the light 221 incident in the light transmitting channel 202 can be reflected at the light reflecting plane 101 in the light transmitting member 201 by the total reflection and then transmitted to a specific light transmitting channel 204 on the output side, or the light 221 incident in the light transmitting channel 202 can be received by the light incident member 209 and is reflected at the light reflecting plane 102 in the light reflecting member 210 by the total reflection, and then transmitted to a specific light transmitting channel 205 on the output side. In such an optical switch, the matrix type actuator according to the present invention can be employed, instead of the actuator member 211 generating a bending displacement, so that an optical switch providing high contrast and low power loss can be achieved.

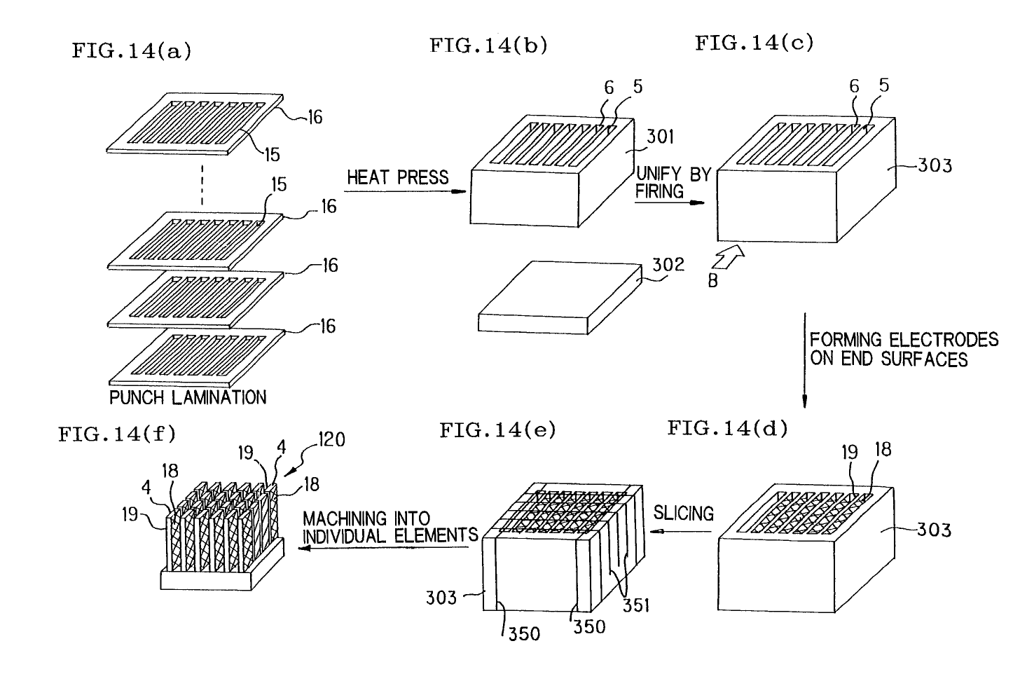

In the following, the method for manufacturing the matrix type actuator according to the present invention will be described. An example of the process employed in the method for manufacturing the first matrix type actuator according to the present invention is schematically shown in FIGS. 14(a) to (f). In this case, the method for manufacturing, for instance, the matrix type actuator 120 shown in FIG. 12 will be described. Firstly, a predetermined number of ceramic green sheets 16 (hereafter being simply referred to as sheets) having the below-described piezoelectric/electrostrictive material as a main component are prepared. These sheets can be produced by the conventional method for producing a ceramic. A powder of the below described piezoelectric/electrostrictive materials is prepared, and by adding a binder, solvent, dispersing agent, plasticizer and the like thereto, a slurry having desired components is produced, and then a ceramic green sheet is produced after the treatment of degassing therein with a sheet forming method, such as the doctor blade method, the reverse roll coating method, or the like.

In FIG. 14(a), each ceramic green sheet 16 is machined with a punch, and slit apertures 15 are formed in each green sheet 16. A predetermined number of these sheets are laminated and then compressed against each other, and after that a ceramic green sheet lamination structure 301 having a predetermined thickness and slits 5, where it includes a piezoelectric/electrostrictive material as a main component, is formed, as shown in FIG. 14(b). On the other hand, a predetermined number of plate-shaped ceramic green sheets, which are machined in a predetermined external shape and contain a piezoelectric/electrostrictive material similar to the above, are prepared, and similarly laminated and compressed against each other, thereby, the part of the ceramic substrate being formed as a ceramic green substrate 302. The ceramic green lamination structure 301 and the ceramic green substrate 302 are adjusted into a desired position, and then they are laminated and compressed against each other. Thereby, a sintered lamination structure 303 can be obtained after sintering and unifying (FIG. 14(c)). Subsequently, electrodes 18 and 19 are formed, as shown in FIG. 14(d), and unnecessary parts are removed by cutting them along cutting lines 350 or slicing lines 351 with a dicing process, slicing process, wire-sawing process or the like, as shown in FIG. 14(e), thus enabling individual piezoelectric/electrostrictive bodies 4 to be obtained, as shown in FIG. 14(f). Finally, the matrix type actuator 120 is provided after performing the polarization treatment in accordance with the necessity. In the machining of cutting and removing, it is preferable that the slits 5 are filled with a removable resin or the like in advance, thereby enabling the damages to be suppressed in the machining process.

In the method of positioning the ceramic green sheets 16 in the process of lamination, the positioning is carried out either by sequentially stacking the ceramic green sheets 16, for instance, inside a frame having an inner space whose shape is approximately identical with the outer shape of the ceramic green sheets 16, by sequentially stacking the ceramic green sheets 16, in which case a guide pin is passed through a hole of each sheet , which is formed in advance. After that, the ceramic green lamination structure 301 can be formed by compressing under heating. In this case, the plane plates shown in FIGS. 9 and 11 can also be formed from the same material and can be laminated, compressed, and then sintered to be unified. In the above method, the ceramic green lamination structure 301 and the ceramic green substrate 302 are separately formed by the lamination, and then further combined by the lamination. However, it is possible to simultaneously laminate all of the green sheets 16. These procedures can be applied as a modified one in the manufacturing methods described below.

Moreover, it is more desirable that a simultaneous punching and laminating procedure is employed in the method of laminating and positioning the ceramic green sheets 16. The simultaneous punching and laminating procedure means a method of producing a ceramic green lamination structure 301 having a predetermined thickness and containing piezoelectric/electrostrictive material in which slits 5 are formed, where slit apertures 15 are formed in the ceramic green sheets 16 in FIG. 14(a), and at the same time the sheets 16 are laminated with the method mentioned below, and slit apertures 15 are formed, thereby the lamination is completed together with the completion of punching.

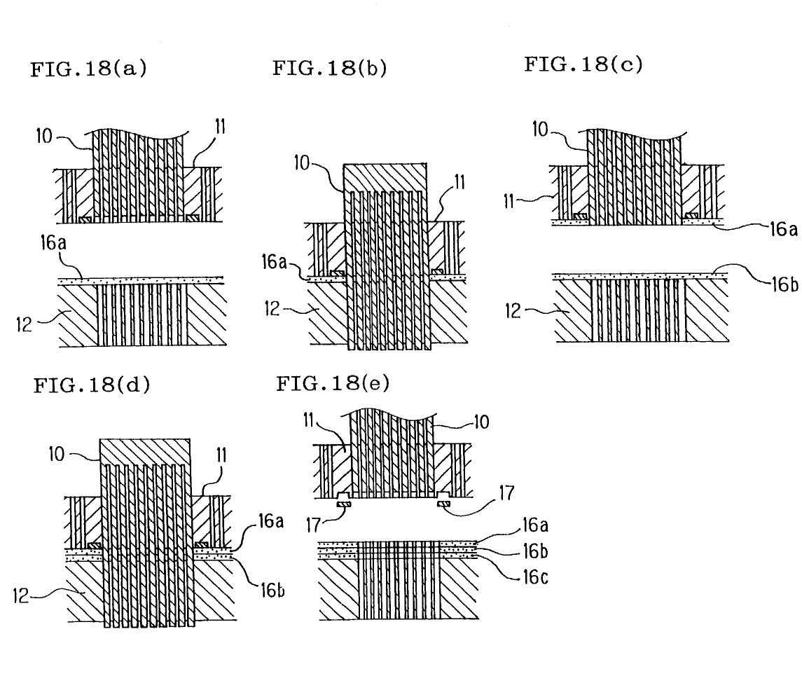

FIGS. 18(a) to (e) show a concrete method of simultaneously punching and laminating, wherein a stripper 11 for laminating the sheets 16 is disposed around the sheets and a die assembly consisting of a punch 10 and a die 12 is used. FIG. 18(a) shows a state in which a first sheet 16a is placed on the die 12 before punching, and in FIG. 18(b), the punch 10 and the stripper 11 is moved downwards, and thus slit apertures are punched in the sheets 16 (first substep).

Subsequently, a second sheet 16b is ready for punching. In this case, as shown in FIG. 18(c), the first sheet 16a is moved upwards in contact with the stripper 11, and thus removed from the die 12 (second substep). The method in which the sheet 16 comes into contact with the stripper 11 can be realized by providing suction holes in the stripper 11 and by vacuum-evacuating the air and the like therethrough. In order that the second sheet 16b is ready for punching, the punch 10 and the stripper 11 are moved upwards. In the course of the upward movement, it is desirable that the front ends of the punch 10 are not returned inside the slit apertures of the first sheet 16a, and in the procedure of stopping the movement, it is important to stop the front ends at a position at which the front ends are withdrawn slightly from the lowest part of the first sheet 16a (third substep). If the punch 10 is returned to the inside of the apertures of the first sheet 16a or completely inserted into the stripper 11, the apertures are deformed due to the softness of the sheet 16, and therefore the flatness of the side surfaces of the slits 5 is deteriorated in the course of forming the slit 5 by laminating the sheets 16.

FIG. 18(d) shows the process of punching the second sheet 16b. In this case, the second sheet 16b can easily be placed on the die 12 with the procedure in which the first sheet 16a comes into contact with the stripper 11, and therefore the punching can be carried out as in the process of FIG. 18(b), and, at the same time, can be stacked on the first sheet 16a (fourth substep). By repeating the substeps in FIGS. 18(c) and 18 (d), the second sheet 16b is placed on the first sheet 16a punched, and then they are moved upwards (fifth substep). After that, the third sheet 16c is ready for punching. In this case, it is important to stop the punch 10 at the position where it is withdrawn slightly from the front ends of the sheet 16 moved upwards together it (sixth substep). After that, by repeating the fourth substep to the sixth substep, a required number of laminated sheets 16 are repeatedly punched and laminated.

FIG. 18(e) shows the state in which the punching is completed. After a required number of sheets 16 are punched and laminated, the holding of the sheets 16 with the stripper 11 is released, and the sheets 16 thus punched can be removed from the stripper 11. Removing from the stripper can be securely carried out by the removing tool 17 disposed at the lower surface of the stripper 11, as shown in the drawing. The above-mentioned procedure corresponds to the manufacturing method, which is disclosed in Japanese Patent Application No. 2000-280573. With this procedure, the ceramic green lamination structure having a predetermined thickness and slits formed therein are formed, can be obtained.

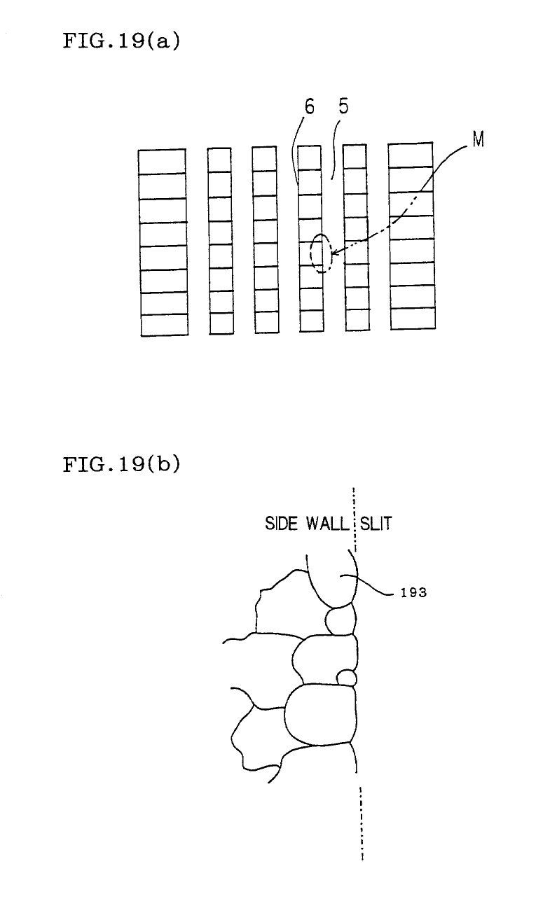

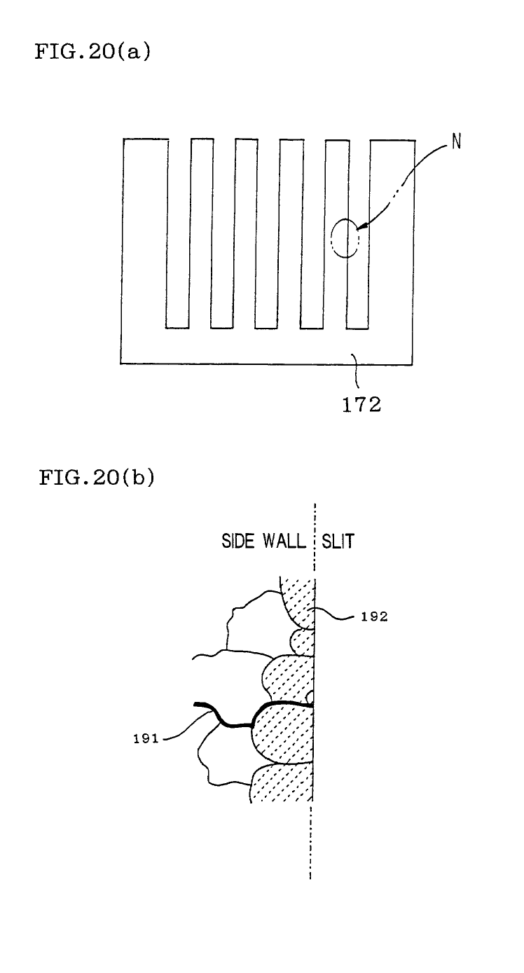

FIG. 19(a) shows a vertical section of a sintered lamination structure 303 formed in the process of FIG. 14(c), viewing from point B, where the lamination structure is formed by using the simultaneous punching and laminating procedure with the punch and the die, and FIG. 19(b) schematically shows a magnified sectional view of part M in the wall surface of the slit 5 shown in FIG. 19(a). FIG. 20(a) is a vertical sectional view of the sintered lamination structure 172 viewed from the side, where the sintered lamination structure 172 is produced by sintering and unifying ceramic green lamination structure having piezoelectric/electrostrictive material as a main component and then by machining the structure with, for example, a dicer to form slits, and FIG. 20(b) schematically shows a magnified sectional view of part N in FIG. 20(a).

In the case of machining the lamination structure with the dicer and the like to form slits after sintering on the lamination structure inclusive of piezoelectric/electrostrictive materials as a major component, micro cracks and/or transgranular fractures of the crystal grains shown in FIG. 20(b) occur, for instance, on the wall surfaces of the slits (micro cracks 191 and ceramic crystal grains 192 of transgranular fractures are shown in FIG. 20 (b)). If, however, the matrix type actuator is produced by forming the slits with the simultaneous punching and laminating procedure before sintering the lamination structure, the side walls of slits 5 which will later become side wall surfaces of the piezoelectric/electrostrictive bodies 4 are formed as sintered surfaces, and as shown in FIG. 19(b), neither micro cracks nor transgranular fractures occur. The condition of the ceramic crystal grains 193 in the surface of the side walls 6, which later become side walls as functional surfaces forming electrodes of the piezoelectric/electrostrictive bodies 4, is that the crystal grains suffering the transgranular fracture is less than 1%, i.e., being substantially the same as zero, and therefore no deterioration of properties occurs, thereby enabling the durability and the reliability to be enhanced. In the present invention, in order to obtain individual piezoelectric/electrostrictive bodies 4, there is a case that the cutting treatment is carried out after sintering. However, the surfaces actually removed are not the surfaces on which electrodes are formed. As can be taken from the first matrix type actuator, the machined surfaces are not the main surfaces for functioning the piezoelectric/electrostrictive elements, so that any effect can scarcely be suffered by such removed surfaces.

Furthermore, if a matrix type actuator is produced by using the simultaneous punching and laminating procedure, the degree of profile for the surface of the piezoelectric/electrostrictive bodies 4 can be set approximately less than 8 μm due to the occurrence of no deviation in stacking. As a result, the displacement and force can be generated with ease in the direction to be intended, and therefore there is an advantage in which the properties of the piezoelectric/electrostrictive elements can be effectively used. Moreover, it is possible to reduce the surface roughness Rt of the wall surfaces of the piezoelectric/electrostrictive bodies 4 down to approximately less than 10 μm. Since the wall surfaces of the piezoelectric/electrostrictive bodies 4 acting as an operating portion are smooth, the concentration of electric field or stress can hardly occurs, thereby enabling a more stable operation of activation to be realized.

In conjunction with the above, the degree of profile is specified in Japanese Industrial Standard B0621, “Definition and representation of geometrical deviation”. The profile of a surface means a surface which is specified in such a manner that it has a functionally determined shape, and the degree of profile for a surface means the magnitude of the deviation of the surface profile from the geometrical profile which is determined by theoretically accurate dimensions.

An example of the accuracy in stacking the ceramic green sheets by the simultaneous punching and laminating procedure will be represented herein. In the case of laminating ten ceramic green sheets each having a thickness of 50 μm and a Young's modulus of 39 N/mm², after punching them so as to have a slit width of 50 μm and a thickness of the piezoelectric/electrostrictive bodies (T in FIG. 1) of 30 μm, the deviation between the layers after sintering is at best 4 μm and the surface roughness Rt is 7 μm, so that the side surfaces of the piezoelectric/electrostrictive bodies can be formed to become very smooth. In this case, the slit width after sintering was 40 μm due to the shrinkage in the sintering.

As described above, the simultaneous punching and laminating procedure ensures forming slit apertures in the ceramic green sheets using the punch and die, and at the same time, laminating the ceramic green sheets, in which case, the punch itself is used as an axis for positioning the ceramic green sheets in the lamination, so that the deformation of the slit apertures machined by the punch can be suppressed. As a result, no deformation of the slit apertures occurs, and the deviation between the laminated ceramic green sheets can be suppressed to be less than 5 μm, so that a lamination structure can be obtained with high accuracy, thereby enabling smooth and flat wall surfaces of the slits to be formed in the obtained lamination structure. Since there are substantially neither micro cracks nor transgranular fracture in crystal grains on the main side surfaces of the piezoelectric/electrostrictive bodies, no deterioration of the properties due to the residual compression stress occurs. Hence, even if many piezoelectric/electrostrictive bodies are arranged in the form of matrix on the substrate, an actuator having excellent properties can be obtained.

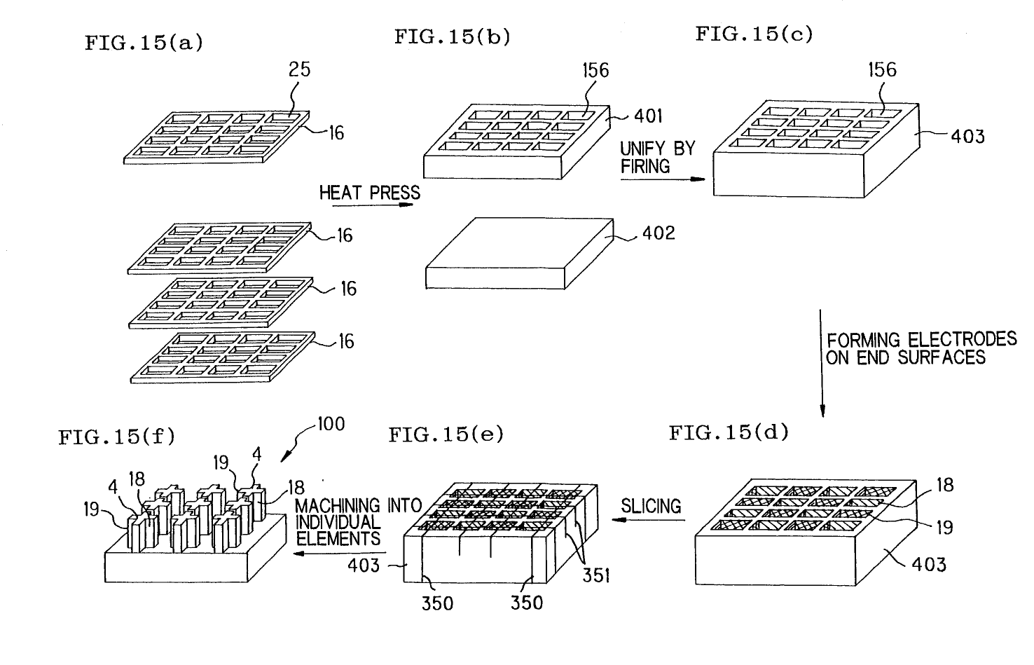

Another example of a process in a method for manufacturing a matrix type actuator is schematically shown in FIGS. 15(a) to 15(f), where the method for manufacturing, for example, a matrix type actuator 100 shown in FIG. 10 is described. Firstly, a predetermined number of ceramic green sheets 16 containing a piezoelectric/electrostrictive material as a main component are prepared. In FIG. 15(a), each ceramic green sheet 16 is punched with a punch, and square-shaped holes 25 are formed in each ceramic green sheet 16. By laminating and compressing these sheets, a ceramic green lamination structure 401 having a predetermined thickness is formed as shown in FIG. 15(b), where square-shaped openings 156 are formed in the ceramic green lamination structure 401 containing the piezoelectric/electrostrictive material as a main component. On the other hand, a part to be a ceramic substrate is formed as a ceramic green substrate 402 by preparing plate-shaped ceramic green sheets which have a predetermined size only for the external shape and contain the same piezoelectric/electrostrictive material and by laminating and compressing a predetermined number of the sheets. The ceramic green lamination structure 401 and the ceramic green substrate 402 are laminated and compressed against each other after positioning. After that, a sintered lamination structure 403 can be produced by sintering and unifying them (FIG. 15(c)). Subsequently, as shown in FIG. 15(d), electrodes 18 and 19 are formed, and then unnecessary parts are removed by dicing machining, or slicing machining, or wire-saw machining them along cutting lines 350 or slicing lines 351, as shown in FIG. 15(e). Finally, individual piezoelectric/electrostrictive bodies 4 can be obtained, as shown in FIG. 14(f). After that, by performing the treatment of polarization in accordance with the necessity, a matrix type actuator 100 can be obtained. In the machining of slicing and removing, it is preferable that the square-shaped openings 156 are filled with a removable resin or the like, thereby preventing the damage in the machining. As a method for positioning and laminating the ceramic green sheets 16, the above-mentioned simultaneous punching and laminating procedure can be preferably employed.

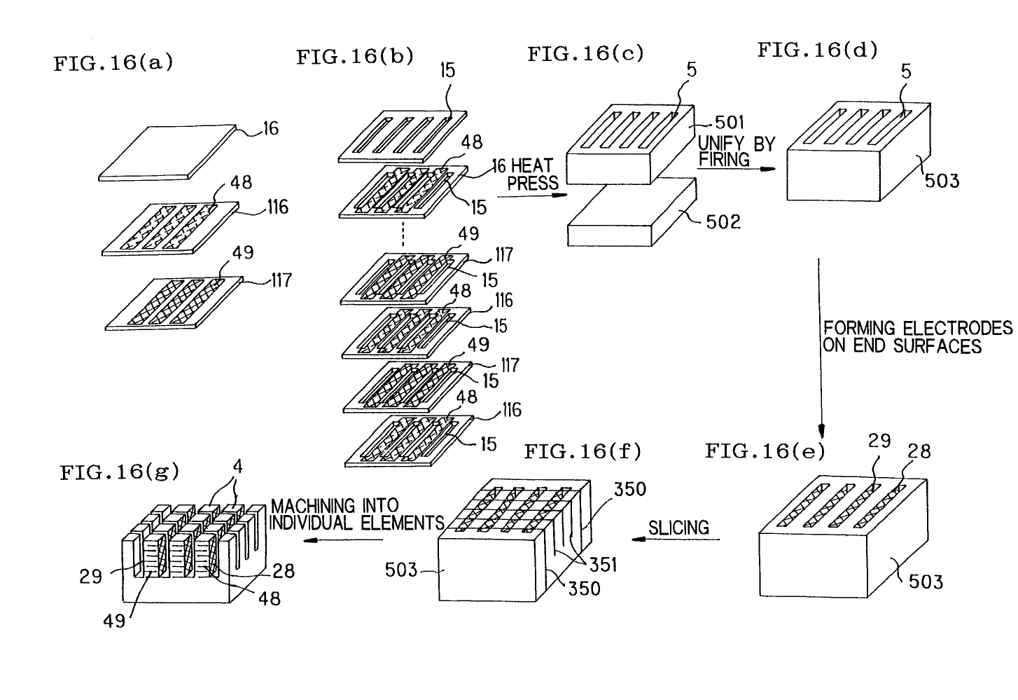

In the following, an example of a process of a method for manufacturing the second matrix type conductor is schematically shown in FIGS. 16(a) to 16(g). Firstly, as shown in FIG. 16(a), a predetermined number of ceramic green sheets 16 containing piezoelectric/electrostrictive material as a main component are prepared. Except for one sheet of a top plate, an electrical conductor material for internal electrodes 48 is applied to half of the sheets remained by the screen printing method or the like, and ceramic green sheets 116 on which layer electrodes are formed can be obtained. Furthermore, an electrical conductor material for internal electrodes 49 is applied to half of the sheets remained by the screen printing method or the like, and ceramic green sheets 117 on which layer electrodes are formed can be obtained. In FIG. 16(b), the ceramic green sheets 16, 116 and 117 are each punched with the punch and slit apertures 15 are thus formed in each of the green sheets 16, 116 and 117. As shown in FIG. 16(c), the ceramic green sheets 116 and 117 are alternately laminated, and then compressed against each other. After that, a ceramic green lamination structure 501 having a predetermined thickness and slits 5 can be formed. On the other hand, a part to be a ceramic substrate is formed as a ceramic green substrate 502 by preparing plate-shaped ceramic green sheets which have a predetermine size only for the external shape and contains the same piezoelectric/electrostrictive material as a main component, and similarly by laminating and compressing a predetermined number of the sheets. The ceramic green lamination structure 501 and the ceramic green substrate 502 are laminated and compressed against each other after positioning. After that, a sintered lamination structure 503 can be produced by sintering and unifying them (FIG. 16(d)). Subsequently, as shown in FIG. 16(e), electrodes 28 and 29 are formed, and then unnecessary parts are removed by dicing machining, or slicing machining, or wire-saw machining them along cutting lines 350 or slicing lines 351, as shown in FIG. 16(f). Finally, individual piezoelectric/electrostrictive bodies 4 can be obtained, as shown in FIG. 14(g). After that, by performing the treatment of polarization in accordance with the necessity, a matrix type actuator can be obtained. In the machining of slicing and removing, it is preferable that the slits 5 are filled with a removable resin or the like, thereby preventing the damage in the machining. As a method for positioning and laminating the ceramic green sheets 16, 116 and 117, the above-mentioned simultaneous punching and laminating procedure can be preferably employed.

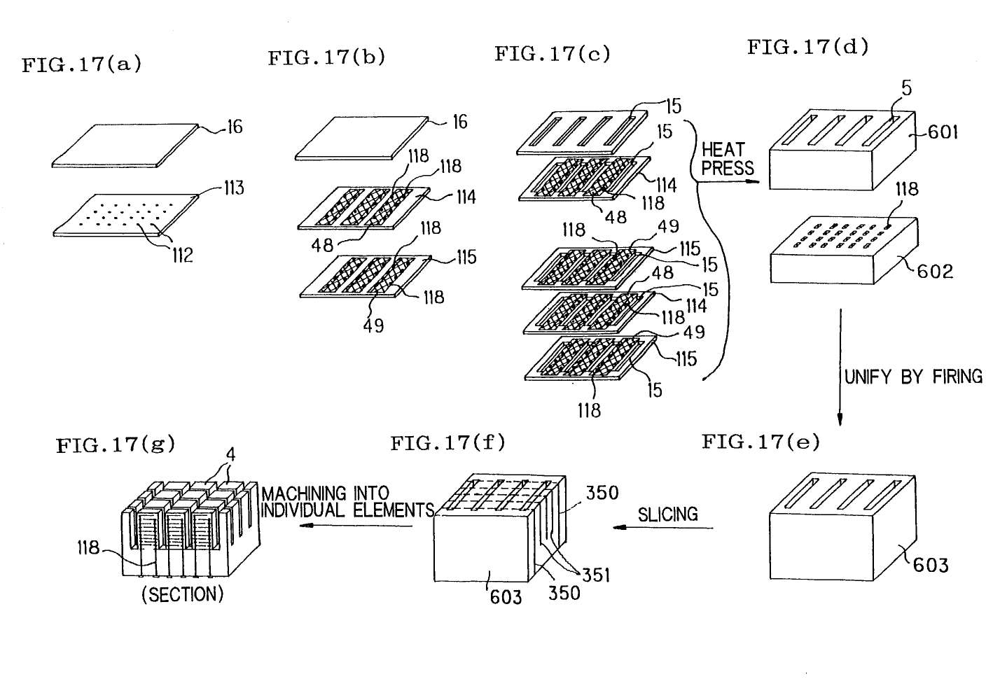

Another example of a process of a method for manufacturing the second matrix type actuator are schematically shown in FIGS. 17(a) to 17(g). Firstly, as shown in FIG. 17(a), a predetermined number of ceramic green sheets containing piezoelectric/electrostrictive material as a main component are prepared. Except for one sheet of a top plate, a desired number of ceramic green sheets 113 are obtained by forming via holes 112 arranged in a predetermined spacing in the remained green sheets 16. In FIG. 17(b), an electrical conductor material for internal electrodes 48 is applied to half of the ceramic green sheets 113 with the screen printing method or the like, and further the via holes 112 are filled with the conductor material, thus obtaining ceramic green sheets 114. Moreover, an electrical conductor material for internal electrodes 49 is applied to half of the remained sheets with the screen printing method or the like and the via holes 112 are filled with the conductor material, thus obtaining ceramic green sheets 115. In FIG. 17(c), the ceramic green sheets 16, 114 and 115 are each punched with the punch and slit apertures 15 are formed in each of the ceramic green sheets 16, 114 and 115. In FIG. 17(d), the ceramic green sheets 116 and 117 are alternately laminated together with the ceramic green sheet 16 and compressed against each other, and thus a ceramic green lamination structure 601 having a pre determined thickness and slits 5 can be formed. On the other hand, regarding a part to be a ceramic substrate, a desired number of ceramic green sheets, preferably made of the same material as the sheet 16 and in which via holes 118 filled with conductor material are formed are prepared, and by sequentially laminating and compressing these sheets a ceramic green substrate 602 is formed. Subsequently, the ceramic green lamination structure 601 and the ceramic green substrate 602 are laminated and compressed against each other after positioning, and a sintered lamination structure 603 is formed by sintering and unifying them (FIG. 17(e)). Subsequently, unnecessary parts are removed with the dicing machining, slicing machining, wire-saw machining or the like along cutting lines 350 or slicing lines 351, as shown in FIG. 17(f), and thus individual piezoelectric/electrostrictive bodies 4 can be obtained, as shown in FIG. 17(g). After that, a treatment of polarization is carried out in accordance with the necessity, and thus a matrix type actuator can be obtained. In the machining of slicing and removing, it is preferable that the slits 5 are filled with a removable resin or the like, thereby preventing the damage in the machining. As a method for positioning and laminating the ceramic green sheets 16, 114 and 115, the above-mentioned simultaneous punching and laminating a procedure can be preferably employed. In conjunction with the above, the formation of electrodes on the side surfaces of the piezoelectric/electrostrictive bodies can be carried out with the aid of sputtering, vacuum evaporation, CVD, plating, coating, spray or the like in the above-mentioned manufacturing methods shown in FIGS. 14, 15 and 16. In this case, it is important to perform the above treatment by masking in order to avoid a short circuit of the paired electrodes. Moreover, in the case that the initial height (under a state of the non-operation) of each piezoelectric/electrostrictive element is accurately adjusted to a fixed value, the flatness of the activation surface is enhanced, the action is effectively transmitted to the objects, and the like, it is preferable to polish the elements before or after the cutting process shown in the drawings. When performing the process of grinding, the treatment of masking is not always necessary in the above-mentioned formation of the electrodes. For instance, a pair of electrodes can be produced by initially forming an electrode layer on the whole surface of the elements and then by cutting the electrode layer with the procedure of grinding. Accordingly, it is preferable since both activation surfaces and paired electrodes may be able to form simultaneously without masking. Additionally, in the case of manufacturing the first matrix type actuator according to FIGS. 14 and 15, a ceramic green sheet having a thicker thickness may be employed as far as the workability and the cross section of the punched shape at the time of punching are within a satisfactory range because the thickness of the green sheet does not have a relationship to the applied voltage; whereas a consideration is required on the thickness of the ceramic green sheet from the viewpoint of the driving voltage in the case of the second matrix type actuator. Therefore, the first matrix type actuator may be said to be an advantageous structure from the man-hour viewpoint since the number in the lamination layers may be reduced. In the above, the embodiments of the matrix type actuator and the methods for manufacturing the actuator are described. Regarding the two dimensional arrangement, the cross angle between the lines in the arrangement can be set to be not 90°, but 30° or 45°, and therefore, can be determined in accordance with the aim and the type of the application. The thickness of the ceramic substrate might be within such a range that the substrate is not deformed with the maximum generating force of the piezoelectric/electrostrictive elements disposed thereon; for example, it may be the same level as the height of piezoelectric/electrostrictive element. Moreover, the surface of the piezoelectric/electrostrictive element itself can be used as the activation surface of the piezoelectric/electrostrictive element. However, the surface of the piezoelectric/electrostrictive element, said surface being covered with an element made of another material, can be used as the activation surface in accordance with the hardness of an object suffering the action and the frequency of its usage. Regarding the electrode terminals for activating the respective piezoelectric/electrostrictive elements, the description is made exclusively on the terminals that are formed on the back surface of the piezoelectric/electrostrictive element. However, the terminals can be formed on the surface on which the piezoelectric/electrostrictive elements are disposed. Moreover, when the electrode terminals are formed on the back surface of the ceramic substrate, it also is desirable that a printed circuit board in which driver IC's for the piezoelectric/electrostrictive elements are assembled is mounted on the electrode terminals.

In the following, the materials used for the matrix type actuator according to the present invention will be described. Firstly, the material for a piezoelectric/electrostrictive body as an activation member, that is, the piezoelectric/electrostrictive material will be described.

As a piezoelectric/electrostrictive material, any of the materials which provide an electric field induced strain such as piezoelectric effect or electrostrictive effect can be employed. Either a crystalline material or an amorphous material can be used, and it is possible to use a semiconductor ceramics or ferroelectric ceramics or antiferroelectric ceramics. The material should be appropriately selected among them in accordance with the type of the application, and the material, which is either necessary or unnecessary for treating polarization, can also be employed. Moreover, the material is not restricted to a ceramic material, but a piezoelectric material made of a polymer such as PVDF (polyvinylidene fluoride) or the like, or a composite material of such a polymer and a ceramics can be used. In this case, however, the elements are produced not by sintering due to the heating-resisting property of the polymer, but by the heat treatment providing a thermosetting property to the polymer.

As for a concrete example, a ceramics such as lead zirconate, lead titanate, lead magnesium niobate, lead nickel niobate, lead zinc niobate, lead manganese niobate, lead antimony stannate, lead manganese tungustate, lead cobalt niobate, barium titanate, sodium bismuth titanate, potassium sodium niobate, strontium bismuth titanate, or the like can be employed as a piezoelectric ceramics or an electrostrictive ceramics. These ceramics should preferably be a main component of a ceramics, forming the piezoelectric/electrostrictive bodies and should be contained in the ceramic at more than 50 wt %. Regarding the material component having a greater electro-mechanical coupling factor and a greater piezoelectric constant, and a higher stability in the process of sintering, a material containing lead zirconate titanate (PZT system) as a main component, a material containing lead magnesium niobate (PMN system) as a main component, a material containing lead nickel niobate (PNN system) as a main component, a material containing a mixture of lead zirconate, lead titanate and lead magnesium niobate as a main component, a material containing a mixture of lead zirconate, lead titanate and lead nickel niobate as a main component, or a material containing sodium bismuth titanate as a main component is preferably used.

Moreover, a ceramic including one or more oxides of lanthanum, calcium, strontium, molybdenum, tungsten, barium, niobium, zinc, nickel, manganese, cerium, cadmium, chromium, cobalt, antimony, iron, yttrium, tantalum, lithium, bismuth, tin, or the like in the above-mention material can be used. For instance, an addition of lanthanum and/or strontium to a main component of the mixture of lead zirconate, lead titanate and lead magnesium niobate makes it possible to adjust the coercive field and the piezoelectric property.

As for the antiferroelectric ceramics, a ceramics containing lead zirconate as a main component, a ceramics containing a mixture of lead zirconate and lead stannate as a main component, a ceramics containing a mixture of lead zirconate and lead titanate as a main component, and lead nickel niobate added thereto, or the like can be employed. Moreover, as for the material of ceramic substrate, all of the materials, which can be sintered together with the piezoelectric/electrostrictive bodies to unify them, can be used. It is preferable that the material is the same as that of the piezoelectric/electrostrictive bodies to be unified, and it is more preferable that the material has the same component and the same composition thereof as that of the piezoelectric/electrostrictive bodies.

In conjunction with the above, if a greater mechanical strength is desired in designing piezoelectric/electrostrictive bodies as an activation part, it is preferable that the mean grain size in the crystal grains of the ceramics is 0.05 to 2 μm. This is due to an increase in the mechanical strength of the piezoelectric/electrostrictive bodies acting as an activation part. If a greater expansion/contraction property is desired in designing piezoelectric/electrostrictive bodies as an activation part, it is preferable that the mean grain size in the crystal grains is 1 to 7 μm. This is due to an increase in the expansion/contraction property.

As the material for components (cover plate, valve body and the like) coupled to the piezoelectric/electrostrictive elements, it is desirable that the material has the same thermal expansion coefficient as the piezoelectric/electrostrictive bodies. In particular, it is preferable that the material is a ceramics and can be unified with the piezoelectric/electrostrictive bodies in the process of lamination and sintering. In this case, it is possible that the material is the same ceramics as the piezoelectric/electrostrictive bodies or different therefrom. In addition, it is not necessary to use a ceramics as for the material, because the preferable properties, such as hardness, required for its usage can be varied. For instance, a gum, an organic resin, an organic adhesive film, a glass, a metal and others can be used. Moreover, the material prepared by mixing a filler to the above-mentioned non-ceramic sub-stances can be effectively used to suppress the shrinkage during the hardening. When a ceramics is employed, a stabilized zirconium oxide, aluminum oxide, magnesium oxide, titan oxide, spinel, mullite, aluminum nitride, silicon nitride, glass, or a mixture thereof may be used.

As the material for the electrodes, the useful material is varied according to the process. If the electrodes are fired together with the piezoelectric/electrostrictive material, it is necessary for the material to endure an oxidizing atmosphere at a high temperature, and therefore there is no limitation for the material so long as it satisfies the above requirements. For instance, metal or alloy can be used, and further a mixture of zirconium oxide, hafnium oxide, titanium oxide, cerium oxide or the like and metal or alloy can be used. More preferably, an electrode material containing a noble metal having a high melting point, such as platinum, palladium, rhodium or the like, or an alloy such as sliver and palladium, silver and platinum, platinum and palladium or the like as a main component, or a mixture of platinum and substrate material or piezoelectric/electrostrictive material and/or a cermet material can favorably be used. Regarding the electrodes formed after sintering the piezoelectric/electrostrictive bodies, for instance, formed on the side surfaces of the piezoelectric/electrostrictive bodies in the first matrix type actuator, the material should be solid at an ordinary temperature.

Including the above-mentioned materials, a metal such as aluminum, titanium, chromium, iron, cobalt, nickel, copper, zinc, niobium, molybdenum, rhenium, silver, tin, tantalum, tungsten, gold, lead or the like or an alloy thereof can be used.

As described above in detail, in accordance with the present invention, the problems in the prior art can be solved, i.e., a matrix type piezoelectric/electrostrictive actuator which ensures providing a greater displacement with a lower voltage, a high responsive speed, and a greater generating force, and at the same time enhancing the mounting ability and the integration as well as a method for manufacturing such a actuator can be provided. The matrix type actuator can be advantageously used in an optical modulator, an optical switch, an electrical switch, a micro valve, a conveyor apparatus, a pump, a droplet ejecting apparatus, an image display apparatus, an image drawing apparatus, and the like.

What is claimed is:

1. A matrix type actuator as a piezoelectric/electrostrictive actuator in which a plurality of piezoelectric/electrostrictive elements each consisting of a piezoelectric/electrostrictive body and at least one pair of electrodes are formed on a thick ceramic substrate, said actuator being activated by the displacement of said piezoelectric/electrostrictive bodies,
characterized in that said piezoelectric/electrostrictive elements are joined to said ceramic substrate into respective unified bodies, and are two-dimensionally arranged independently of each other.

2. A matrix type actuator according to claim 1, wherein said electrodes are formed on the side surfaces of said piezoelectric/electrostrictive bodies disposed on said ceramic substrate in said piezoelectric/electrostrictive elements.

3. A matrix type actuator according to claim 2, wherein said piezoelectric/electrostrictive elements are expanded/contracted vertically to the main surface of said ceramic substrate in the displacement of said piezoelectric/electrostrictive bodies due to a transverse effect of an electric field induced strain.

4. A matrix type actuator according to claim 2, wherein conditions of crystal grains in the wall surfaces of the piezoelectric/electrostrictive bodies of said piezoelectric/electrostrictive elements, where said electrodes are formed on the wall surfaces, is that the crystal grains suffering a transgranular fracture is less than 1%.

5. A matrix type actuator according to claim 2, wherein the degree of profile for the surfaces of the piezoelectric/electrostrictive bodies in said piezoelectric/electrostrictive elements is approximately 8 μm or less.

6. A matrix type actuator according to claim 2, wherein the surface roughness Rt of the wall surfaces of the piezoelectric/electrostrictive bodies in said piezoelectric/electrostrictive element is approximately 10 μm or less.

7. A matrix type actuator according to claim 1, wherein said piezoelectric/electrostrictive elements are formed on said ceramic substrate by alternately laminating a plurality of stratiform piezoelectric/electrostrictive bodies, and a plurality of stratiform electrodes.

8. A matrix type actuator according to claim 7, wherein said piezoelectric/electrostrictive elements are expanded/contracted vertically to main surface of said ceramic substrate in displacement of said piezoelectric/electrostrictive bodies due to a longitudinal effect of the electric field induced strain.

9. A matrix type actuator according to claim 7, wherein a thickness per layer of said piezoelectric/electrostrictive body in said piezoelectric/electrostrictive elements is 100 μm or less.

10. A matrix type actuator according to claim 7, wherein number of layers being composed of said piezoelectric/electrostrictive body in said piezoelectric/electrostrictive element is 10 to 100.

11. A matrix type actuator according to claim 1, wherein said piezoelectric/electrostrictive body is formed of a material selected from the group consisting of piezoelectric ceramics, electrostrictive ceramics, and antiferroelectric ceramics and a composite material of at least one of said ceramic materials and a piezoelectric polymer.

12. A matrix type actuator according to claim 1, wherein said ceramic substrate and said piezoelectric/electrostrictive elements are made of same material.

13. A matrix type actuator according to claim 1, wherein electrode terminals are disposed on the surface opposite to the surface on which said piezoelectric/electrostrictive elements are arranged in said ceramic substrate, and said electrodes and said electrode terminals are wired to each other via through holes or via holes formed in said ceramic substrate.

14. A method for manufacturing a matrix type actuator, in which a plurality of piezoelectric/electrostrictive elements consisting of a piezoelectric/electrostrictive body and at least one pair of electrodes are two-dimensionally arranged on a thick ceramic substrate; characterized in that said method comprising:
a step A for obtaining ceramic green lamination structure having through apertures, wherein a plurality of ceramic green sheets including piezoelectric/electrostrictive material as a main component are prepared, said ceramic green sheets are machined with a punch and a die to form apertures at predetermined positions and laminated, and thus the through apertures are formed by connecting said apertures to each other;
a step B for preparing ceramic green substrates forming a ceramic substrate;
a step C for obtaining a sintered lamination structure by laminating said ceramic green lamination structure and said ceramic green substrate and then by sintering and unifying them; and
a step D for slicing said sintered lamination structure at the portion corresponding to the ceramic green lamination structure obtained at least said step A;
said method further comprises a process for forming a plurality of independent piezoelectric/electrostrictive elements on the ceramic substrate.

15. A method for manufacturing a matrix type actuator according to claim 14, wherein said step A includes,
a first substep for forming first apertures in a first ceramic green sheet with said punch, a second substep for raising said first ceramic green sheet in contact with a stripper in the state of not withdrawing said punch from said first aperture, a third substep for raising said punch in such a manner that the front ends of said punch are withdrawn slightly from the lowest part of said first green sheet raised,
a fourth substep for forming second apertures in a second ceramic green sheet with said punch, a fifth substep for raising said second green sheet together with said first ceramic green sheet, and a sixth substep for raising said punch in such a manner that the front ends of said punch are withdrawn slightly from the lowest part of said second ceramic green sheet,
whereby the lamination is carried out by repeating the fourth substep to sixth substep, and then the ceramic green lamination structure having through apertures formed by the connection of the apertures can be obtained.

16. A method for manufacturing a matrix type actuator according to claim 14, wherein further a step for filling the through apertures of said sintered lamination structure at the portion corresponding to said ceramic green lamination structure with a filler is interposed between said step C and said step D.
